(19) United States
(12) Patent Application Publication
(10) Pub. No.: US 2006/0117259 A1
(43) Pub. Date: Jun. 1, 2006

(54) Apparatus and method for adapting graphics contents and system therefor

(76) Inventors: Je-Ho Nam, Seoul (KR); Jin-Woo Hong, Daejon (KR); Jin-Woong Kim, Daejon (KR); Hae-Kwang Kim, Seoul (KR); Nam-Ik Cho, Seoul (KR); Hyoung-Joong Kim, Seoul (KR); Man-Bae Kim, Gangwon-do (KR); Rin-Chul Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/537,214

(22) PCT Filed: Dec. 3, 2003
(86) PCT No.: PCT/KR03/02636

§ 371 Date: Jan. 9, 2006

(30) Foreign Application Priority Data
Dec. 3, 2002 (KR) 10-2002-0076421

(51) Int. Cl. H04N 5/44; H04N 7/173; G11B 27/00

(52) U.S. Cl. 715/719

(57) ABSTRACT

Apparatus and method for adapting graphics contents and system therefore is provided. The apparatus and method provide the best experience of digital contents a user by adapting the digital contents to the user's graphics presentation preference. The apparatus for adapting graphics contents includes a graphics usage environment management unit and a graphics adaptation unit.

### TECHNICAL FIELD

The present invention relates to an apparatus for adapting graphics contents and a method thereof; and, more particularly, to an apparatus for adapting graphics contents to usage environment information that includes user terminal characteristics and user presentation preference, and a method thereof. The graphics contents mentioned in this specification are defined to include two-dimensional graphics contents, three-dimensional graphics contents, and animation graphics contents. This specification will concentrate on the subject of the graphics contents in describing the present invention.

### BACKGROUND ART

Moving Picture Experts Group (MPEG) presented Digital Item Adaptation (DIA), which is a new standard working item of MPEG-21. Digital Item (DI) means a structured digital object with a standard representation, identification and meta-data. The DIA is a process for adapting DI in a resource adaptation engine and/or a descriptor adaptation engine to thereby generate adapted DI.

The term ‘resource’ indicates an asset that can be identified individually, such as video or audio clips, and image or textual asset. It may indicate a physical object. The term ‘descriptor’ denotes information related to components or components of DI. The term ‘user’ mentioned in the present specification includes a producer, right owner, distributor, or consumer of a DI. Media resource denotes a content that can be presented in a digital expression directly. In this specification, the term ‘content’ is used in the same meaning as DI, media resource, and resource.

Conventional technologies have a problem that they cannot provide a single-source multi-use environment where one graphics content is adapted to different usage environments. The usage environment can be described by information on user characteristics, natural environment, and terminal capability.

‘Single source’ denotes a content generated from a multimedia source. ‘Multi-use’ means that the single source is consumed by various user terminals having different usage environments.

The single-source multi-use environment has such an advantage that it can provide diverse shapes of contents adapted to different usage environments by re-processing a single content to be adapted to diverse usage environments. Further, it can reduce the network bandwidth efficiently when it adapts a single source to a variety of usage environments.

Accordingly, in the single-source multi-use environment, content providers can reduce unnecessary cost for producing and transmitting a plurality of contents adapted to diverse usage environments. Also, content consumers can consume optimum graphics contents that most satisfy their user preference.

Recently, it is increasing remarkably to demand graphics contents in diverse application areas, such as games, medical diagnosis, Computer-Aided Design/Computer-Aided Manufacturing (CAD/CAM), education and amusements, through diverse user terminals, such as personal computers (PC), personal digital assistants (PDA), and mobile phones.

Producers produce graphics contents using their creativeness freely. The graphics contents have an advantage that their data transmission amount is relatively small in the respect of visual communication. However, there is a disadvantage that they require a large amount of computation when they are rendered in an end user terminal.

In the conventional ways of consuming multimedia contents, such as the Internet, contents are consumed in the user terminal just as they are transmitted from a server. Therefore, there is a problem in producing and transmitting three-dimensional graphics or animation contents in consideration of diverse characteristics of user terminals, processing performance, and user's presentation preference.

### DISCLOSURE OF INVENTION

It is, therefore, an object of the present invention to provide an apparatus for adapting graphics contents, using usage environment information which includes predescribed user terminal characteristics and graphics presentation preference.

In accordance with one aspect of the present invention, there is provided an apparatus for adapting graphics contents to use a single source for multiple uses, including: a graphics usage environment information managing unit for collecting, describing and managing graphics usage environment information from a user terminal that consumes the graphics contents; and a graphics adapting unit for adapting the graphics contents to the graphics usage environment information of the user terminal and outputting the adapted graphics contents to the user terminal, wherein the graphics usage environment information includes user terminal characteristics information and graphics presentation preference information.

In accordance with one aspect of the present invention, there is provided a method for adapting graphics contents for using a single source for multiple usages, including the steps of: a) collecting, describing and managing graphics usage environment information from a user terminal that consumes the graphics contents; and b) adapting the graphics contents to the graphics usage environment information of the user terminal and outputting the adapted graphics contents to the user terminal, wherein the graphics usage environment information includes user terminal characteristics information and graphics presentation preference information.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram illustrating an apparatus for adapting graphics in accordance with an embodiment of the present invention;

FIG. 2 is a block diagram showing the graphics adapting apparatus of FIG. 1 in accordance with an embodiment of the present invention;

FIG. 3 is a flowchart describing a graphics adapting process in the graphics adapting apparatus of FIG. 1;

FIG. 4 is a flowchart illustrating the adaptation process in the step S305 of FIG. 3; and

FIG. 5 shows examples of a graphics content in which a GeometryQuality descriptor is changed in accordance with an embodiment of the present invention.

### BEST MODE FOR CARRYING OUT THE INVENTION

Other objects and aspects of the invention will become apparent from the following description of the embodiments with reference to the accompanying drawings, which is set forth hereinafter.

Following description exemplifies only the principles of the present invention. Even if they are not described or illustrated clearly in the present specification, one of ordinary skill in the art can embody the principles of the present invention and invent various apparatuses within the concept and scope of the present invention.

The use of the conditional terms and embodiments presented in the present specification are intended only to make the concept of the present invention understood, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like.

To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

Other objects and aspects of the invention will become apparent from the following description of the embodiments with reference to the accompanying drawings, which is set forth hereinafter. The same reference numeral is given to the same element, although the element appears in different drawings. In addition, if further detailed description on the related prior arts is determined to blur the point of the present invention, the description is omitted. Hereafter, preferred embodiments of the present invention will be described in detail with reference to the drawings.

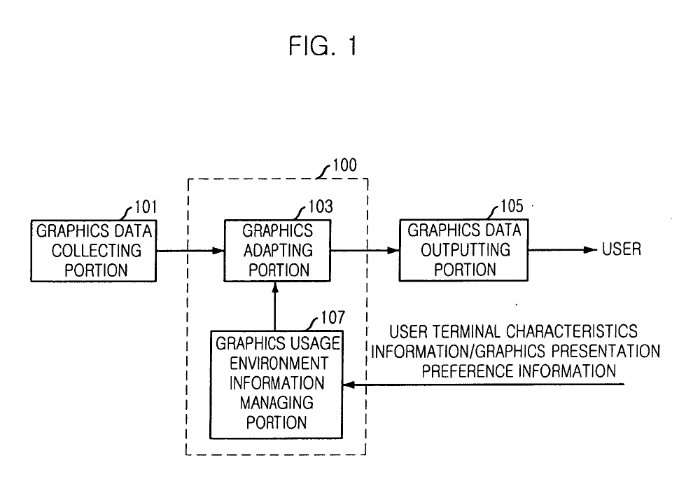

FIG. 1 is a block diagram illustrating an apparatus for adapting graphics in accordance with an embodiment of the present invention. The graphics adapting apparatus 100 of the present invention includes a graphics adapting portion 103 and a graphics usage environment information managing portion 107.

Each of the graphics adapting portion 103 and the graphics usage environment information managing portion 107 can be mounted on a graphics processing system independently. The graphics processing system includes a laptop computer, a desktop computer, a workstation, a main frame computer, and other types of computers. It also includes other types of data processing systems or signal processing systems such as PDA and mobile stations in mobile communication.

The graphics processing system can be any one among the nodes that form a network path, i.e., a multimedia node system, a multimedia relay node system, and an end user terminal. The end user terminal is equipped with a player, e.g., Windows Media Player, Real Player and the like.

For example, when the graphics adapting apparatus 100 is mounted on the multimedia source node system and operated, the graphics adapting apparatus 100 receives information on usage environment from the end user terminal, adapts a content to the received usage environment, and transmit the adapted content to the end user terminal.

To describe the data processing functions and operations of the graphics adapting apparatus 100, such as graphics encoding processing, in accordance with an embodiment of the present invention, the ISO/IEC standard document of the ISO/IEC Technical Committee can be included as part of the present specification within the range that the standard document can help describe the functions and operations of the elements of a preferred embodiment.

A graphics data collecting portion 101 collects graphics data generated in a multimedia source. The graphics data collecting portion 101 can be included in the multimedia source node or in the multimedia relay node system which received graphics data transmitted from the multimedia source node system through a wired/wireless network. Also, it can be included in the end user terminal.

The graphics adapting portion 103 receives graphics data from the graphics data collecting portion 101 and adapts graphics contents to usage environment by using usage environment information obtained by the graphics usage environment information managing portion 107. The usage environment information includes user terminal characteristics and graphics presentation preference.

The function of the graphics adapting portion 103 needs not be included in a certain node system necessarily, but it can be included in the node systems that form the network path.

The graphics usage environment information managing portion 107 collects information from the user terminal, describes the usage environment information of the user terminal in advance, and manages it.

The graphics data outputting portion 105 outputs adapted graphics data obtained by the graphics adapting portion 103. The outputted graphics data can be transmitted to a graphics player of the end user terminal, or transmitted to the multimedia relay node system or the end user terminal through a wired/wireless network.

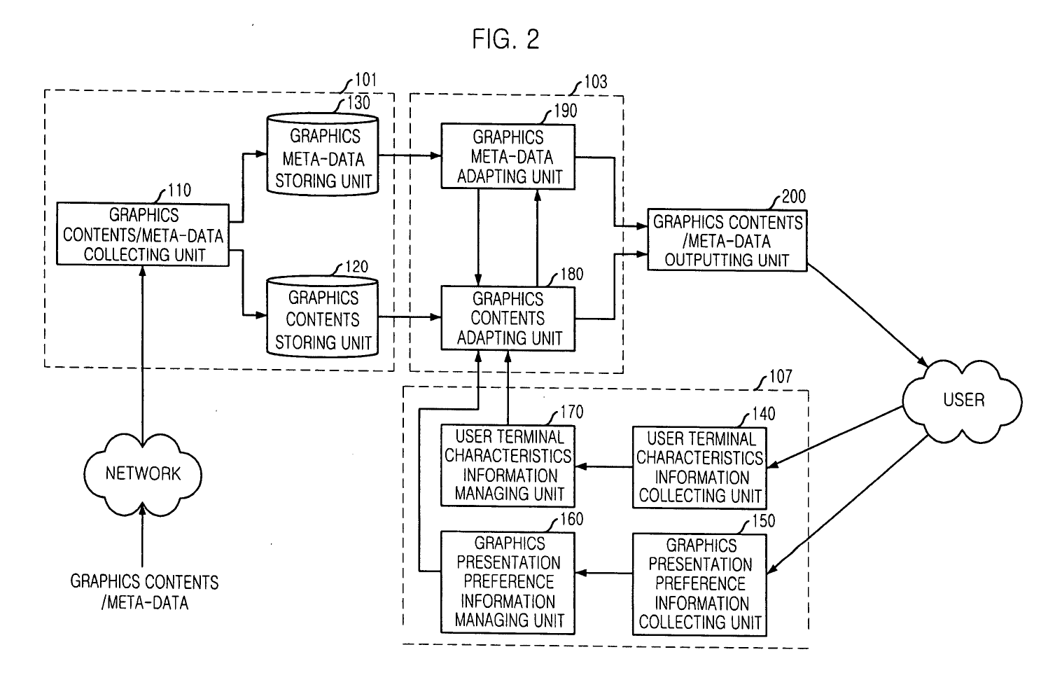

FIG. 2 is a block diagram showing the graphics adapting apparatus of FIG. 1 in accordance with an embodiment of the present invention. In the drawing, the graphics data collecting portion 101 can include a graphics contents/meta-data collecting unit 110, a graphics meta-data storing unit 130, and a graphics contents storing unit 120.

The graphics contents/meta-data collecting unit 110 collects graphics contents and graphics meta-data. The graphics meta-data storing unit 130 stores the collected graphics meta-data. The graphics contents storing unit 120 stores the collected graphics contents.

The graphics contents/meta-data collecting unit 110 transmits terrestrial wave signals, satellite and cable television (TV) signals, and diverse graphics contents and meta-data related to the graphics contents that are obtained through recording-media, such as video cassette recorder (VCR), CD, and DVD, to the graphics contents storing unit 120 and the graphics meta-data storing unit 130 and stores them therein.

Since the graphics contents can include three-dimensional graphics and three-dimensional animation graphics, they can be stored in many different encoding methods. The encoding methods include diverse media formats transmitted in the form of streaming.

Also, the graphics meta-data are described by defining graphics media information, such as the type of graphics contents encoding methods, file size, bit-rate, the number of frames per second (frame/second), and resolution, and defining the production and classification information, such as the title, producer, production site, production date and time, genre and grade of a content in the extensible markup language (XML) schema.

The graphics usage environment information managing portion 107 can include a graphics presentation preference information collecting unit 150, a user terminal characteristics information collecting unit 140, a graphics presentation preference information managing unit 160, and a user terminal characteristics information managing unit 170.

The graphics presentation preference information collecting unit 150 collects and adjusts user's graphics presentation preference information and transmits the collected information to the graphics presentation preference information managing unit 160 in order to adapt a graphics content to a multi-view graphics contents based on the user's specific presentation preferences. The user's graphics presentation preference is related to the performance of the user terminal.

The graphics presentation preference information managing unit 160 records, stores and manages the user presentation preference information in a mechanically readable language, such as the XML schema, and transmits the information to a graphics contents adapting unit 180.

Also, the user terminal characteristics information collecting unit 140 collects and adjusts user terminal characteristics information which is needed for the user terminal to present the graphics contents, and transmits the information to the user terminal characteristics information managing unit 170.

Just as the graphics presentation preference information managing unit 160, the user terminal characteristics information managing unit 170 records, stores and manages the user terminal characteristics information in a mechanically readable language, for example, the XML schema, and transmits the information to the graphics contents adapting unit 180.

The graphics adapting portion 103 can include the graphics contents adapting unit 180 and a graphics meta-data adapting unit 190. The graphics contents adapting unit 180 adapts the graphics contents, and the graphics meta-data adapting unit 190 receives meta-data from the graphics meta-data storing unit 130 and transmits the meta-data to the graphics contents adapting unit 180.

The graphics contents adapting unit 180 parses the graphics presentation preference information managing unit 160 to acquire the user's presentation preference, such as the multi-view preference and the preference for emphasizing the quality of graphics, and adapts the graphics contents to the user's graphics presentation preference.

The graphics contents adapting unit 180 receives the user terminal characteristics information, which has the XML schema, from the user terminal characteristics information managing unit 170, parses the information, and adapts the graphics contents to the characteristics of the user terminal.

The graphics meta-data adapting unit 190 provides meta-data needed for a graphics content adapting process, and adapts the graphics meta-data according to the result of graphics content adaptation.

The graphics data outputting unit 105 can include a graphics contents/meta-data outputting unit 200 for outputting to the user the graphics contents and graphics meta-data, which are transmitted from the graphics contents adapting unit 180 and the graphics meta-data adapting unit 190.

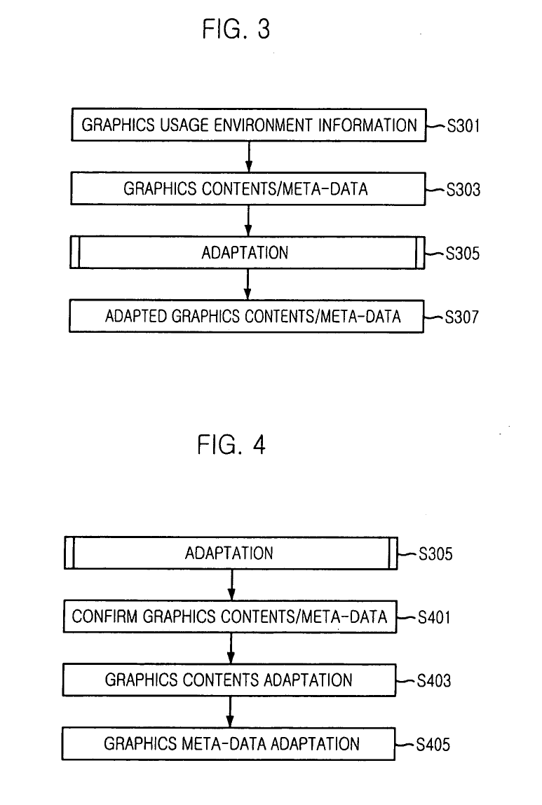

FIG. 3 is a flowchart describing a graphics adapting process in the graphics adapting apparatus of FIG. 1. Referring to the drawing, the process of the present invention begins with the graphics usage environment information managing portion 107 collecting graphics usage environment information from the user terminal and describing user terminal characteristics information and graphics presentation preference information, at step S301.

At step S303, the graphics data collecting portion 101 collects graphics data. Then, at step S305, the graphics adapting portion 103 adapts the graphics data to the usage environment, e.g., the user terminal characteristics and the graphics presentation preference, based on the usage environment information acquired at the step S301. At step S307, the graphics data outputting portion 105 outputs adapted graphic data which is acquired at the step S305.

FIG. 4 is a flowchart illustrating the adaptation process in the step S305 of FIG. 3. At step S401, the graphics adapting portion 103 checks the graphics contents and graphics meta-data collected in the graphics data collecting portion 101. At step S403, it adapts the graphics contents to the user terminal characteristics and the graphics presentation preference. At step S405, it adapts the graphics meta-data in accordance with the result of the graphics content adaptation.

Disclosed, hereafter, is an architecture of description information managed by the graphics usage environment information managing portion 107. The elements of the user terminal characteristics information are shown in Tables 1 and 2 in accordance with the present invention.

TABLE 1
User Terminal Characteristics (CODEC Performance) Information

| Elements | Datatype | Definition |
|---|---|---|
| GraphicsFormat | mpeg7: | Describes graphic |
| | ControlledTermUseType | format supported by |
| | | CODEC of user terminal |

TABLE 2
User Terminal Characteristics (CODEC Performance) Information

| Elements | Datatype | Definition |
|---|---|---|
| Graphics Parameters | | Describes user |
| | | terminal's CODEC |
| | | performance for |
| | | particular graphics |
| vertexProcessing | integer | Describes the maximum |
| Rate | | number of vertices |
| | | processed per second |
| | | (vertices/sec.) |
| fillRate | integer | Describes the maximum |
| | | number of pixels shown |
| | | in screen buffer per |
| | | second (pixels/sec.) |
| memoryBandwidth | integer | Describes the maximum |
| | | rate between graphics |
| | | processor and graphics |
| | | memory (bits/sec.) |

Following is syntax of the XML schema that describes the information related to decoding and/or encoding process of graphics contents. The information is recorded and stored by the user terminal characteristics information managing unit 170.

To begin with, Table 1 can be expressed as follows.

<element name=“GraphicsFormat”

type=“mpeg7:ControlledTermUseType”/>

Also, Table 2 can be expressed as follows.
<element name=“GraphicParameters” minOccurs=“0”>
<sequence>
<element name=“vertexProcessingRate”

type=“integer” minOccurs=“0”/>

<element name=“fillRate”

type=“integer” minOccurs=“0”/>

<element name=“memoryBandwidth”

type=“integer” minOccurs=“0”/>

</sequence>
</element>

The vertexProcessingRate, fillRate and memoryBandwidth descriptors denote graphics content presentation capabilities of the user terminal. The vertexProcessingRate descriptor describes the maximum vertex processing rate of a codec in units of vertices/sec. The fillRate descriptor describes the maximum fill rate of a codec in units of pixels/sec. The fill rate is defined as a product of the image resolution, frame rate, and depth complexity. The memoryBandwidth descriptor describes the maximum bandwidth of a codec in units of bits/sec.

Meanwhile, the elements of the graphics presentation preference information are shown in Table 3.

TABLE 3
Graphics Presentation Preference Information

| Elements | Data Type | Definition |
|---|---|---|
| CameraSourceLocation | mpeg7:floatVector | Describes location |
| | (length = 3) | of camera in |
| | | virtual 3-D scene. |
| 3DtoMultiview2D | | Describes user's |
| | | preference for 2D |
| | | graphics obtained |
| | | with virtual |
| | | cameras having |
| | | different camera |
| | | coefficients. |
| CameraDestLocation | mpeg7:floatVector | Describes direction |
| | (length = 3) | of virtual camera |
| | | in virtual 3-D |
| | | scene. |
| CameraFocalLength | float | Describe focal |
| | | length of virtual |
| | | camera. |
| CameraProjection | String; | Selects projection |
| | Perspective, | type of virtual |
| | Orthographic | camera between |
| | | perspective |
| | | projection and |
| | | orthographic |
| | | projection. |
| CameraFieldOfView | float; | Describes |
| | Minimum = 0.0, | horizontal field of |
| | Maximum = 360.0 | view of virtual |
| | | camera as viewing |
| | | angle degree. |
| CameraAspectRatio | mpeg7: | Describes ratio of |
| | nonNegativeFloat | vertical field of |
| | | view to horizontal |
| | | field of view of |
| | | virtual camera. |
| CameraNearPlane | mpeg7: | Describes near |
| | nonNegativeFloat | clipped plane of |
| | | virtual camera. |
| CameraFarPlane | mpeg7: | Describes far |
| | nonNegativeFloat | clipped plane of |
| | | virtual camera. |
| GeometryQuality | mpeg7:zeroToOneType | Describes quality |
| | | of graphics |
| | | contents |
| | | geometrically |
| | | between 0 and 1. |
| MaterialQuality | mpeg7:zeroToOneType | Describes material |
| | | quality of graphics |
| | | contents between 0 |
| | | and 1. |
| AnimationQuality | mpeg7:zeroToOneType | Describes animation |
| | | rendering quality |
| | | of graphics |
| | | contents between 0 |
| | | and 1. |
| 3Dcoord | mpeg7:floatVector | Describes location |
| | (length = 3) | of a spot in |
| | | Cartesian 3D |
| | | coordinates. The |
| | | value 3 indicates |
| | | x, y, z-axial |
| | | location. |

Following is syntax of the XML schema that describes the graphics presentation preference information which is recorded and stored by the graphics presentation preference information managing unit 160.

<element name=“GraphicsPresentationPreference”

```
  type=“dia:GraphicsPresentationPreferenceType”
  minOccurs=“0”/>
```

<complexType

name=“GraphicsPresentationPreferenceType”>

<sequence>
<element name=“3DtoMultivew2D” minOccurs=“0”>
<complexType>
<sequence maxOccurs=“unbounded”>
<element name=“CameraSourceLocation” type=“3Dcoord”/>
<element name=“CameraDestLocation” type=“3Dcoord”/>
<element name=“CameraFocallength” type=“float”/>
<element name=“Camerapprojection” minOccurs=“0”/>
<simpleType>
<restriction base=string“>”
<enumeration value=Perspective”>
<enumeration value=“Orthographic”>
</restriction>
</simpleType>
</element>
<element name =“CameraFieldOfView”>
<simpleType>
<restriction base=“float”>
<minInclusive value=“0.0”>
<maxInclusie value=“360.0”>
</restriction>
</simpleType>
</element>
<element name=“CamerAspectRatio”

type=“mpeg7:nonNegativeFloat”/>

<element name=“CameraNearPlane”

type=“mpeg7:nonNegativeFloat”>

<element name=“CameraFarPlane”

type=“mpeg7:nonNegativeFloat”>

</sequence>
</complexType>
</element>
<element name=“GeometryQuality”

type=“mpeg7:zeroToOneType”/>

<element name=“MaterialQuality”

type=“mpeg7:zeroToOneType”/>

<element name=“AnimationQuality”

type=“mpeg7:zeroToOneType”/>

</sequence>
</complexType>
<simpleType name=“3Dcoord”>
<restriction base=“mpeg7:floatVector”/>
<minLength value=“3”/>
<maxLength value=“3”/>
</restriction>
</simpleType>

Among the graphics presentation preference information, the GeometryQuality descriptor emphasizes the geometry quality of graphic objects of a graphics content. It stresses the geometric preference of the user.

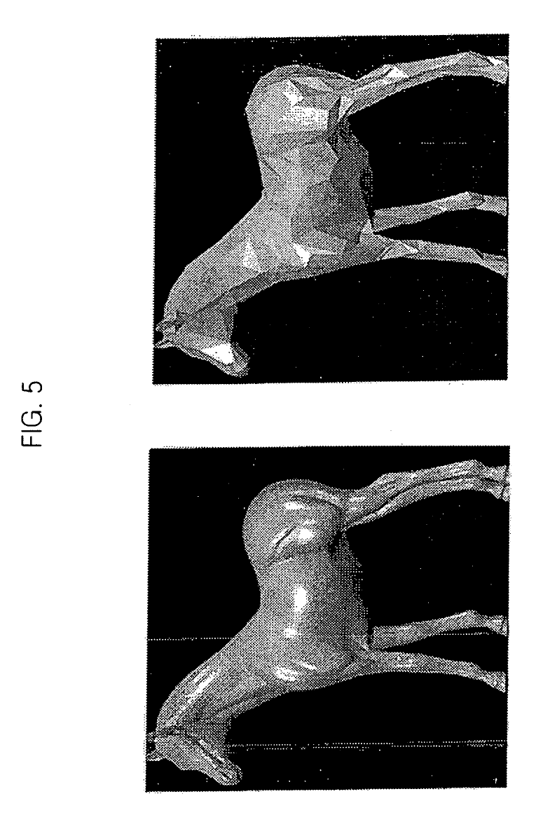

FIG. 5 shows examples of a graphics content in which the GeometryQuality descriptor is changed in accordance with an embodiment of the present invention. The geometric characteristics of graphics contents, i.e., geometry quality, can be emphasized by setting the GeometryQuality descriptor at a value between 0 and 1.

For example, when the GeometryQuality descriptor is set at 1, the original of the graphics contents are transmitted. When the GeometryQuality descriptor is set at 0.4 and graphic objects of a graphics content are formed of 100 triangular meshes, the geometric characteristics of the graphic objects are presented in a quality lower than the original quality by reducing the number of the triangular meshes down to 40.

The MaterialQuality descriptor emphasizes the material characteristics, such as texture, of graphic objects of a graphics content. The MaterialQuality descriptor includes texture emphasis preferred by a user regarding the degradation of the texture for graphics. It puts an emphasis on the user's preference for material. The material quality of the graphics content can be emphasized by setting the MaterialQuality descriptor at a value between 0 and 1.

For example, if the MaterialQuality descriptor is set at 1, all the material characteristics the graphics content has originally are transmitted. If the MaterialQuality descriptor is set at 0.04 and graphic objects of a graphics content are formed of 100×100 pixels, the material characteristics are presented in a lower quality by reducing the materials to 20×20 pixels.

The AnimationQuality descriptor shows the user's preference for the number of pictures presented per second in animation graphic objects. The AnimationQuality descriptor can be set at a value between 0 and 1 to emphasize the animation characteristics, i.e., animation quality.

For example, if the AnimationQuality descriptor is 1, all the animation characteristics a graphics content has originally are transmitted. If the AnimationQuality descriptor is 0.4 and animation graphic objects of a graphics content has 30 key positions, the animation characteristics of the graphics content are presented in a lower quality by reducing the temporal resolution of animation to 12 key positions per second.

As described above, the technology of the present invention can provide a service environment where graphics contents are adapted to different usage environments and diverse user preferences by using the user terminal characteristics information and user presentation preference information.

Also, in the single-source multi-use environment of the present invention, one graphics content is reprocessed to be adapted to different environments and user requests, such as the performances and capabilities of diverse user terminals and diverse user characteristics, and to be provided quickly. Therefore, it is possible to reduce cost for producing and transmitting a plurality of graphics contents, make users overcome their restrictions in location and environment, while satisfying the users' preferences.

While the present invention has been described with respect to certain preferred embodiments, it will be apparent to those skilled in the art that various changes and modifications may be made without departing from the scope of the invention as defined in the following claims.

What is claimed is:

1. An apparatus for adapting graphics contents to use a single source for multiple uses, comprising:
a graphics usage environment information managing means for collecting, describing and managing graphics usage environment information from a user terminal that consumes the graphics contents; and
a graphics adapting means for adapting the graphics contents to the graphics usage environment information of the user terminal and outputting the adapted graphics contents to the user terminal,
wherein the graphics usage environment information includes user terminal characteristics information and graphics presentation preference information.

2. The apparatus as recited in claim 1, wherein the user terminal characteristics information includes information related to encoding/decoding performance of the user terminal, and
the graphics adapting means adapts the graphics contents based on the information related to encoding/decoding performance and transmits the adapted graphics contents to the user terminal.

3. The apparatus as recited in claim 2, wherein the information related to encoding/decoding performance includes information on the maximum number of vertices processed per second in the user terminal.

4. The apparatus as recited in claim 2, wherein the information related to encoding/decoding performance includes information on the maximum number of pixels shown in a screen buffer of the user terminal per second.

5. The apparatus as recited in claim 2, wherein the information related to encoding/decoding performance includes information on the maximum rate between a graphics processor and a graphics memory of the user terminal.

6. The apparatus as recited in claim 1, wherein the graphics presentation preference information includes preference for geometrical characteristics of graphic objects of the graphics contents, and
the graphics adapting means adapts the graphics contents by changing the geometric characteristics of the graphic objects of the graphics contents and transmits the adapted graphics contents to the user terminal.

7. The apparatus as recited in claim 1, wherein the graphics presentation preference information includes preference for material characteristics of the graphic objects of the graphics contents, and
the graphics adapting means adapts the graphics contents by changing material characteristics of the graphic objects of the graphics contents and transmits the adapted graphics contents to the user terminal.

8. The apparatus as recited in claim 1, wherein the graphics presentation preference information includes user preference for the number of pictures of animation graphic objects shown for one second, and
the graphics adapting means adapts the graphics contents by changing characteristics of the animation graphic objects of the graphics contents based on the user preference and transmits the adapted graphics contents to the user terminal.

9. A method for adapting graphics contents for using a single source for multiple usages, comprising the steps of:
a) collecting, describing and managing graphics usage environment information from a user terminal that consumes the graphics contents; and
b) adapting the graphics contents to the graphics usage environment information of the user terminal and outputting the adapted graphics contents to the user terminal,
wherein the graphics usage environment information includes user terminal characteristics information and graphics presentation preference information.

10. The method as recited in claim 9, wherein the user terminal characteristics information includes information related to encoding/decoding performance of the user terminal, and
in the step b),
the graphics contents are adapted based on the information related to encoding/decoding performance and the adapted graphics contents are transmitted to the user terminal.

11. The apparatus as recited in claim 10, wherein the information related to encoding/decoding performance includes information on the maximum number of vertices processed per second in the user terminal.

12. The apparatus as recited in claim 10, wherein the information related to encoding/decoding performance includes information on the maximum number of pixels shown in a screen buffer of the user terminal per second.

13. The apparatus as recited in claim 10, wherein the information related to encoding/decoding performance includes information on the maximum rate between a graphics processor and a graphics memory of the user terminal.

14. The apparatus as recited in claim 9, wherein the graphics presentation preference information includes preference for geometrical characteristics of graphic objects of the graphics contents, and
in the step b),
the graphics contents are adapted by changing the geometric characteristics of the graphic objects of the graphics contents and the adapted graphics contents are transmitted to the user terminal.

15. The apparatus as recited in claim 9, wherein the graphics presentation preference information includes preference for material characteristics of the graphic objects of the graphics contents, and
in the step b),
the graphics contents are adapted by changing material characteristics of the graphic objects of the graphics contents and the adapted graphics contents are transmitted to the user terminal.

16. The apparatus as recited in claim 9, wherein the graphics presentation preference information includes user preference for the number of pictures of animation graphic objects shown for one second, and
in the step b),
the graphics contents are adapted by changing characteristics of the animation graphic objects of the graphics contents based on the user preference and transmits the adapted graphics contents to the user terminal.
